(19) United States
(12) Patent Application Publication
(10) Pub. No.: US 2014/0058652 A1
(43) Pub. Date: Feb. 27, 2014

(54) TRAFFIC INFORMATION PROCESSING

(71) Applicant: International Business Machines Corporation, Armonk, NY (US)

(72) Inventors: Hou Li Duan, Beijing (CN); Yan Yan Hu, Beijing (CN); Feng Li, Beijing (CN); Shao Chun Li, Beijing (CN); Susan Eileen Skrabanek, Talking Rock, GA (US); Yu Yuan, Beijing (CN)

(73) Assignee: International Business Machines Corporation, Armonk, NY (US)

(21) Appl. No.: 14/010,587

(22) Filed: Aug. 27, 2013

(30) Foreign Application Priority Data
Aug. 27, 2012 (CN) 201210309029.9

(51) Int. Cl. G08G 1/00

(52) U.S. Cl. CPC G08G 1/00
USPC 701/117

(57) ABSTRACT

Traffic information processing method and apparatus. The method includes the steps of: obtaining road traffic data of a plurality of road sections; predicting for at least two road sections of the plurality of road sections, based on the obtained data, traffic flow information at an expected time when arriving at the road section from a current position, the traffic flow information being used for describing a traffic state of a road; displaying via a display apparatus the predicted traffic flow information of at least two road sections in the at least two road sections. In addition, the present invention provides a traffic information processing apparatus, a GPS navigation device, and a variable message board. By applying the technical solution provided in the present invention, the road traffic condition can be effectively transferred to users so that it is convenient for the users to plan routes for their travel.

### CROSS-REFERENCE TO RELATED APPLICATION

This application claims priority under 35 U.S.C. §119 from Chinese Patent Application No. 201210309029.9 filed Aug. 27, 2012 the entire contents of which are incorporated herein by reference.

### BACKGROUND OF THE INVENTION

The present invention relates to intelligent traffic field, and more specifically, to a traffic information processing method, apparatus and corresponding variable message board and GPS navigation device.

In recent years, intelligent transportation technology has become a hot spot in urban construction. People hope to relieve traffic pressure and reasonably arrange their travel by various means.

In order to guide drivers to select routes, variable message boards have been widely employed. However, the current variable message boards can only display real-time traffic information, and thus the drivers can only select routes based on the real-time information. Generally, the variable message boards are disposed at fixed positions, thus a driver at a fixed place can only see the real-time conditions of the roads around that fixed place, while once departure from the fixed place, the driver cannot learn the condition of the road where he/she is driving on and the surrounding road conditions. Since driving lasts for a certain time while the traffic conditions of roads are constantly varying, it is very likely that when a driver drives on a selected route, the condition of the road is already far from that previously shown on the variable message board. This may probably decrease the user experience of the variable message board users, so that the variable message board's traffic guidance function becomes worse.

### SUMMARY

In order to improve the availability of traffic guidance, embodiments of the present invention provide a traffic information processing method, apparatus and corresponding variable message board and GPS navigation device.

According to an aspect of the present invention, there is provided a traffic information processing method, the method comprising: obtaining road traffic data of a plurality of road sections; predicting for at least two road sections of the plurality of road sections, based on the obtained data, traffic flow information at an expected time when arriving at the road section from a current position, the traffic flow information being used for describing a traffic state of a road; displaying via a display apparatus the predicted traffic flow information of at least two road sections in the at least two road sections.

According to another aspect of the present invention, there is provided a traffic information processing apparatus, the apparatus including: an obtaining module configured to obtain road traffic data of a plurality of road sections; a predicting module configured to predict for at least two road sections of the plurality of road sections, based on the obtained data, traffic flow information at an expected time when arriving at the road section from a current position, wherein the traffic flow information is used for describing a traffic state of a road; a display module configured to display via a display apparatus the predicted traffic flow information of at least two road sections in the at least two road sections.

According to yet another aspect of the present invention, there is provided a variable message board, including a display apparatus and the traffic information processing apparatus described above.

According to yet another aspect of the present invention, there is provided a GPS navigation device, including a display apparatus and the traffic information processing apparatus described above.

The technical solution provided in the present invention can increase the availability of traffic guidance so that a user can better select a route for travel.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement the embodiments of the present invention;

FIG. 2 shows a flow schematic diagram of a traffic information processing method according to an embodiment of the present invention;

FIG. 3 shows an example of displaying traffic flow information by a variable message board according to an embodiment of the present invention;

FIG. 4 shows a flow schematic diagram of an implementation for Step 220 of FIG. 2;

FIG. 5 shows an example of employing a BP neural network model as a predicting model according to an embodiment of the present invention;

FIG. 6 shows a structure schematic diagram of a traffic information processing method according to an embodiment of the present invention;

FIG. 7 shows a structure schematic diagram of a variable message board according to an embodiment of the present invention;

FIG. 8 shows a structure schematic diagram of a GPS navigation device according to an embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

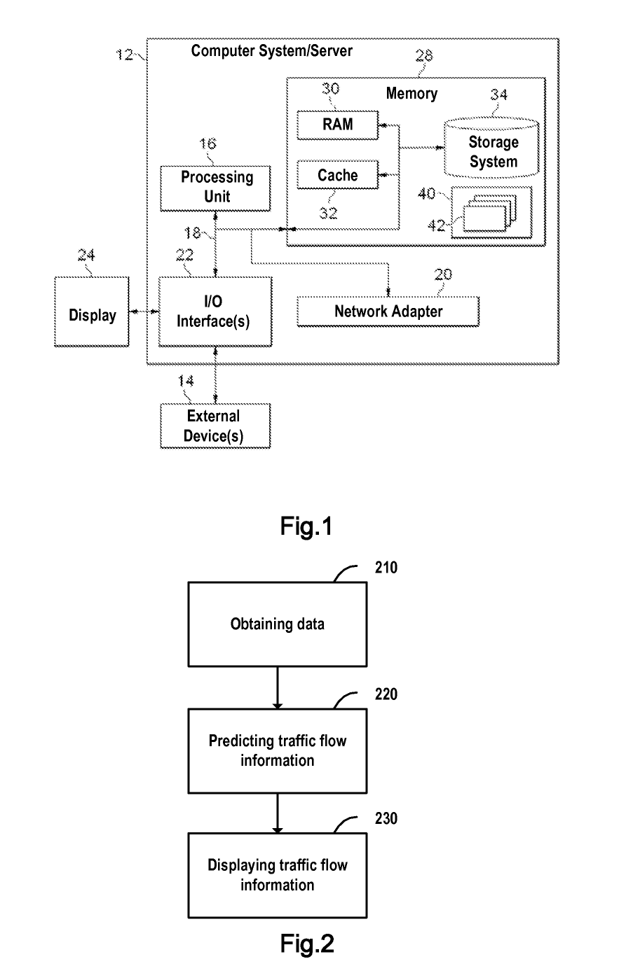

With reference now to FIG. 2, FIG. 2 shows a traffic information processing method provided in embodiments of the present invention. The method comprises: Step 210, obtaining road traffic data of a plurality of road sections; Step 220, predicting for at least two road sections of the plurality of road sections, based on the obtained data, traffic flow information at an expected time when arriving at the road section from a current position; Step 230, displaying via a display apparatus the predicted traffic flow information of at least two road sections in the at least two road sections.

Those skilled in the art would understand that in Step 220, the traffic flow information at the expected time when arriving at each road section of the plurality of road sections from the current position can be predicted. In addition, in Step 230, the traffic flow information of all road sections or part of the road sections of the predicted road sections can be displayed. For example, when the method is applied to a variable message board, the traffic flow information of all predicted road sections can be displayed, while when the method is applied to a GPS navigation device, the traffic flow information of part of the road sections in the predicted road sections or the traffic flow information of the road sections contained in a route selected by a user can be displayed only.

This embodiment predicts and displays the future traffic flow information with collected data so that a driver can obtain an indication of road traffic conditions of different road sections within a time period in the future. Furthermore, in this embodiment, for different road sections, the traffic flow information at different time is displayed and especially the traffic flow information at an expected time when arriving at different road sections from a current position is displayed, so that the driver can make a more accurate route selection. It can be understood that if for all road sections, the displayed traffic flow information is for the same time, even if it is the predicted traffic flow information, it is hard for a driver to learn possible traffic flow information of a certain road section when the driver is expected to arrive at the certain road section and thus it is still hard for the driver to accurately select a route. For example, P and Q routes are available for a driver to select from the current position to a destination position, wherein P consists of road section 1, road section 2 and road section 3, while Q consists of road section 4, road section 5 and road section 6. If at a current moment, road section 1 and road section 4 are smooth; road section 2 and road section 5 are slow; while road section 3 is smooth and road section 6 is congested. According to the prior art, the traffic flow information of the above 6 road sections at the current moment will be provided to the driver, and then the driver may probably select route P for travel. However, road section 2 will become congested in 10 minutes; road section 3 will become slow in 20 minutes; and road section 6 will become smooth in 15 minutes. Then, it will obviously consume more time if the driver selects route P compared with selecting route Q. Thus, the driver deems that the provided traffic flow information is wrong or unpractical. However, according to the method provided in this embodiment, the current traffic flow information of road section 1 and road section 4, the traffic flow information of road section 2 and road section 5 in 10 minutes, the traffic flow information of road section 3 in 20 minutes, and the traffic flow information of road section 6 in 15 minutes can be displayed. Thus, the driver can see that road section 1 and road section 4 are currently smooth while road section 2 will be congested in 10 minutes; road section 5 will be slow in 10 minutes; road section 3 will be slow in 20 minutes; while road section 6 will be smooth in 15 minutes. Then the driver can select route Q to arrive at the destination. It can be seen that the information finally displayed to a user with the method provided in this embodiment is more accurate and practical and can greatly improve the user's faith in the displayed information, and thus can play a better role in traffic guidance and meanwhile improve user's experience.

If the method provided in this embodiment is used for a public traffic information prompt system, e.g. a variable message board, the expected time when arriving at the road section from a current position is an assumed time, e.g. an expected time of arrival obtained with average conditions or statistical conditions. If the method provided in this embodiment is used for a personal traffic information prompt system, e.g. a GPS navigation device, the expected time when arriving at the road section from a current position can be the time of arrival expected according to the actual situation of the user of the GPS navigation device. It can be seen that with the method provided in this embodiment, the driver can accurately know the traffic condition of each road section of the selectable route at his/her possible time of arrival, and thus the driver can better select a route for driving and avoid a blind road selection so that the traffic guidance can play the best role.

In one embodiment of the present invention, traffic flow information is used to describe the traffic state of a road. For example, the traffic flow information may include traveling speeds of vehicles on a road, a traffic flow amount and one or more of other parameters capable of describing the traffic state of a road.

In one embodiment of the present invention, road traffic data may be obtained directly from a traffic detection device and may also be obtained from an intermediate device such as a data exchange center, a data management center, etc. The traffic detection device is a device capable of collecting various road traffic data, e.g. including one or more of a floating car device, an automatic number plate recognition ANPR system, a road monitoring camera, a microwave detecting device and a coil detecting device. Those skilled in the art would understand that data may also be collected by other traffic detection devices which are not enumerated. Embodiments of the present invention do not limit the means for obtaining road traffic data, and the road traffic data may be obtained by wireless or wired transmission and may also be obtained by other intermediate devices.

In one embodiment of the present invention, the current position may be a position where the display apparatus is currently located. Those skilled in the art would understand that the current position may also be in a short distance away from the position where the display apparatus is currently located, and it is not necessarily the exact position where the display apparatus is currently located.

In one embodiment of the present invention, the display apparatus is a device capable of displaying traffic flow information to a user, e.g. it may be a display apparatus in a variable message board and may also be a display apparatus in a GPS navigation device.

In one embodiment of the present invention, the expected time when arriving at the road section from a current position in Step 220 may be an expected time point of arrival at the road section or may be an expected time period of arrival at the road section. In this embodiment, the time point of arrival at the road section may be a time point of arrival at the starting point of the road section and may also be the time point of arrival at the terminating point of the road section, and may further be the time point of arrival at any point of the road section. In this embodiment, the time point of arrival at the road section may further be an average value or a statistic value. In this embodiment, the time period of arrival at the road section may be a period of time including the above exemplary time points.

In one embodiment of the present invention, Step 220 may include: pre-processing the obtained data and predicting, based on the pre-processed data, traffic flow information of a plurality of road sections at different time, wherein pre-processing the obtained data, for example, is to perform one or more of the following operations on the obtained data: abnormal data removal, missing data compensation, data format conversion, etc.

In one embodiment of the present invention, Step 220 may include: matching the obtained data with an electronic map to obtain standby traffic flow information of a plurality of road sections; predicting, based on the standby traffic flow information of a plurality of road sections, traffic flow information of the plurality of road sections at different time, wherein the standby traffic flow information includes at least one of historical traffic flow information and real-time traffic flow information. Those skilled in the art would understand that the real-time traffic flow information may generally include at least one of: the traffic flow information at the current moment, the traffic flow information at a previous moment, the traffic flow information within a time period adjacent to the previous moment, and the traffic flow information at a plurality of moments before the current moment. The historical traffic flow information generally includes the traffic flow information before a period of time, e.g. the traffic flow information before one day, or the traffic flow information before one week, or the traffic flow information before one month, etc. The electronic map includes a plurality of road sections, and thus the standby traffic flow information of different road sections can be obtained directly by matching the data with the electronic map. Those skilled in the art would understand that the standby traffic flow information of a plurality of road sections can also be obtained directly without the matching with the electronic map, e.g. the standby traffic flow information of a plurality of road sections can also be obtained by directly analyzing the spatio-temporal identification of traffic data.

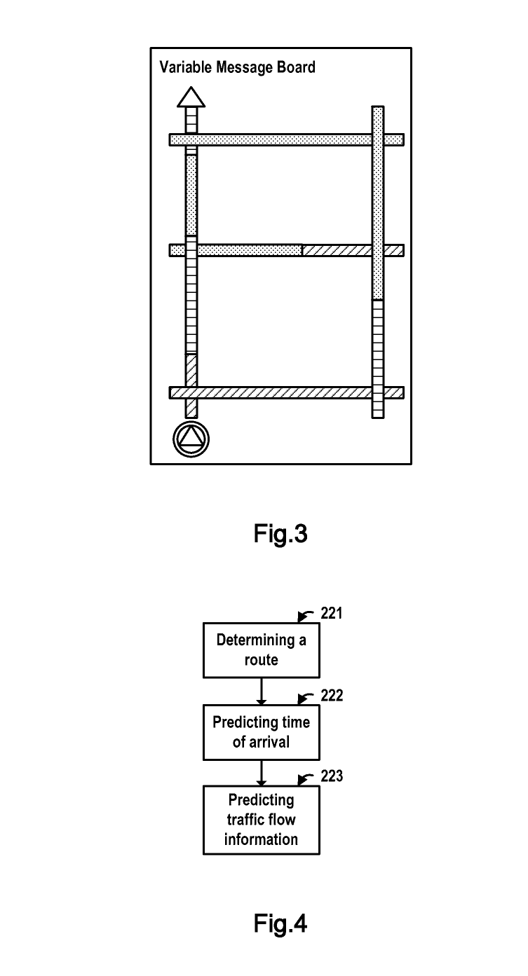

In one embodiment of the present invention, when displaying the traffic flow information of at least two road sections, Step 230 may directly display the traffic flow information and may also display by other means symbols, colors, etc. capable of indicating the traffic flow information. For example, the traffic flow information may be divided into three types, i.e. congested, smooth and slow, based on a threshold, and the display apparatus may represent congested, smooth and slow traffic respectively by different colors. FIG. 3 shows an example of a variable message board as the display apparatus for displaying the traffic flow information, wherein the horizontal line portion indicates congested traffic; the oblique line portion indicates slow traffic and the dot portion indicates smooth traffic. In the displaying, Step 230 may display the predicted traffic flow information of all road sections and may also display the predicted traffic flow information of part of the road sections only. In addition, it may further display the real-time traffic flow information of the road section where the current position is located, or the real-time traffic flow information of its adjacent road sections.

In one embodiment of the present invention, Step 220 may include: taking traffic guidance information as an influencing factor for prediction, and predicting for at least two road sections of the plurality of road sections, based on the obtained data, traffic flow information at an expected time when arriving at the road section from a current position, wherein the traffic guidance information comprises at least part of the information displayed by the display apparatus. Once a driver sees the traffic guidance information, the driver may select a smoother route as indicated by the traffic guidance information for travel, rather than keep traveling according to the original route, and thus the traffic guidance information will influence the predicted traffic flow information. It can be seen that in the predicting, taking into account the influence of the traffic guidance information on the driver may make the predicted result more accurate and thereby further improve the credibility of the traffic guidance.

In one embodiment of the present invention, as shown in FIG. 4, Step 220 may include: Step 221, determining a route from a current position to a destination road section; Step 222, predicting time of arrival at the destination road section via the determined route; Step 223, predicting traffic flow information of the destination road section at the time of arrival; wherein a plurality of road sections to be predicted may be taken respectively as the destination road sections to obtain the traffic flow information at an expected time of arrival at the road section. The route may include the destination road section and may not include the destination road section, and it varies in specific calculations. In order to facilitate the description of the following embodiments, the following explanations are made by taking the route not including the destination road section as an example.

In one embodiment of the present invention, Step 221 may include: judging, based on a behavior predicting model, a most probably selected route from the current position to the destination road section and taking the most probably selected route as the finally determined route. For the display apparatus disposed at a fixed position such as a variable message board, etc., the current position is the position where the display apparatus is located, while for the display apparatus whose position is variable such as a GPS navigation device, etc., the current position is the position where the display apparatus is currently located.

In one embodiment of the present invention, if the method is used for the GPS navigation device, a plurality of routes from the current position to the destination road section may be taken one by one as the determined routes so as to display the traffic conditions of the plurality of routes to the user.

In one embodiment of the present invention, if the method is used for the GPS navigation device, the route that has been planned for a user to arrive at the destination road section may be taken as the determined route, wherein the route that has been planned for a user to arrive at the destination road section can be obtained based on the route planning technology of the GPS navigation device in prior art, and thus is not detailed here.

In one embodiment of the present invention, judging, based on a behavior predicting model, a most probably selected route from the current position of the display apparatus to the destination road section, for example, may comprise one of the following or any combination thereof: taking the route requiring the shortest travel time as the most probably selected route; taking the route having the shortest length as the most probably selected route; taking the route having the maximum traffic flow as the most probably selected route; taking the route charging the least as the most probably selected route; taking the route having the minimum intersections as the most probably selected route. Those skilled in the art may understand that there may be other behavior predicting models and thus it is not detailed here.

In one embodiment of the present invention, Step 222 may include: respectively obtaining a time length Tᵢ required for passing through each road section of the determined route, wherein Tᵢ is obtained based on the traffic flow information of a corresponding road section at time tᵢ, 1≦i≦k, t₁ is the current time, tᵢ=tᵢ₋₁+Tᵢ₋₁, k is the number of the road sections contained in the determined route; obtaining the time of arrival based on the obtained time lengths required for passing through respective road sections. Where the traffic flow information of the first road section on the determined route at time t₁ can be obtained directly because t₁ is the current time; the traffic flow information of the other road sections (the i-th road section, 1<i≦k) on the determined route at tᵢ time can be obtained by prediction. For example, the implementation of Step 222 may be divided into the following steps: A. determining the traffic flow information of the first road section on the determined route at the current time; B. obtaining, based on the traffic flow information at time tᵢ, the time length Tᵢ required for passing through the i-th road section, wherein 1≦i≦k−1, t₁ is the current time, k is the number of the road sections contained in the determined route; C. predicting the traffic flow information of the (i+1)-th road section on the determined route at time tᵢ₊₁, wherein tᵢ₊₁=tᵢ+Tᵢ; D. repeating the above steps B and C until obtaining the time length Tₖ required for passing through the k-th road section; E. obtaining the time of arrival based on the obtained time lengths required for passing through respective road sections on the determined route. In the following, it will be explained in detail by an example that the determined route M includes road section 1, road section 2, road section 3 and road section 4 and that the traffic flow information is velocity V. Firstly, it needs to determine the traffic flow information V₁ of the road section 1 at the current time t₁. Then, the time length required for passing through the road section 1 is obtained based on T₁=L₁/V₁, wherein L₁ is the length of the road section 1. Thereafter, the traffic flow information V₂ of the road section 2 at time t₂ is predicted, wherein t₂=t₁+T₁. Then, the time length required for passing through the road section 2 is obtained based on T₂=L₂/V₂, wherein L₂ is the length of the road section 2. The rest can be deducted in the same manner until the time length T₄ required for passing through the road section 4 is obtained. T₁, T₂, T₃ and T₄ are summed to obtain the time required for passing through the entire route and the time of arrival can be obtained based on the current time t₁. Those skilled in the art would understand that the current time t₁ may also be set as 0, and thus the time of arrival can be obtained directly by summing T₁, T₂, T₃ and T₄, and t₁ does not have to be considered in the above calculation. Furthermore, tᵢ may be the time at the starting point of the route, i.e. the starting point of the i-th road section, and may also be the time in the middle of the road section or at other places of the road section.

In one embodiment of the present invention, the traffic flow information of a corresponding road section (the i-th road section) at time tᵢ can be obtained by step of: taking at least one of historical traffic flow information of the i-th road section, real-time traffic flow information of the i-th road section and real-time traffic flow information of an upstream road section of the i-th road section as an input to obtain the traffic flow information of the i-th road section at time tᵢ. Alternatively, the real-time traffic flow information of the i-th road section may take the traffic flow information of a plurality of times before the current time, while the real-time traffic flow information of the upstream road section may take the traffic flow information at the current time or the previous time. Still taking the traffic flow information being the velocity as an example, the traffic flow information of the i-th road section at time tᵢ can be obtained based on Vᵢ(tᵢ)=A[a₁Vᵢ₊ₖ(tᵢ−1)+a₂Vᵢ₊ₖ₋₁(tᵢ−1)+a₃Vᵢ₊ₖ₊₁(tᵢ−1)]+B[b₁Vᵢ(tᵢ−1)+b₂Vᵢ(tᵢ−2)+b₃Vᵢ(tᵢ−3)+b₄Vᵢ(tᵢ−4)]+cHᵢ(tᵢ), wherein Vᵢ₊ₖ(tᵢ−1) represents the traffic flow information of the upstream road section i+k at time tᵢ−1, i.e. the real-time traffic flow information of the upstream road section. Alternatively, a vehicle travels on the i+k road section (the upstream road section of the i-th road section) at time t₁−1 while travels to the i-th road section at time tᵢ. The upstream road section comprises the road sections in a direction where the traffic flow is originating and capable of reaching the current road section. Those skilled in the art would understand that the upstream road section may only comprise road sections adjacent to the current road section, and may also comprise more road sections not adjacent to the current road section. Vᵢ(tᵢ−1) represents the traffic flow information of the i-th road section at time tᵢ−1, and B[b₁Vᵢ(tᵢ−1)+b₂Vᵢ(tᵢ−2)+b₃Vᵢ(tᵢ−3)+b₄Vᵢ(tᵢ−4)] represents the real-time traffic flow information of the i-th road section. It can be understood that the calculation of the real-time traffic flow information may have other variations, for example, it could include the traffic flow information at more times, such as, b₅Vᵢ(tᵢ−5). Finally, Hᵢ(tᵢ) represents the historical traffic flow information of the i-th road section at time tᵢ, for example, the traffic flow information of the i-th road section at time tᵢ on yesterday, or the traffic flow information of the i-th road section at time tᵢ on the same day in one week before. The above parameters A, B and a₁, b₁, etc. can be obtained by the calculation with historical data, and can also be set based on experiences. Based on the examples given above, different values can be taken for tᵢ to predict the traffic flow information of the i-th road section at different times in the future. It can be understood that other predicting models may also be employed to obtain the traffic flow information of the i-th road section at different times in the future.

In one embodiment of the present invention, in the above method for obtaining the traffic flow information of a corresponding road section (the i-th road section) at time traffic guidance information may also be taken as an input for the prediction, that is, the traffic flow information of the corresponding road section (the i-th road section) at time tᵢ can be obtained by step of: taking at least one of the historical traffic flow information of the i-th road section, the real-time traffic flow information of the i-th road section and the real-time traffic flow information of the upstream road section of the i-th road section, and the current traffic guidance information as an input to obtain, based on a predicting model, traffic flow information of the i-th road section at time tᵢ wherein the traffic guidance information comprises at least part of the information displayed by the display apparatus.

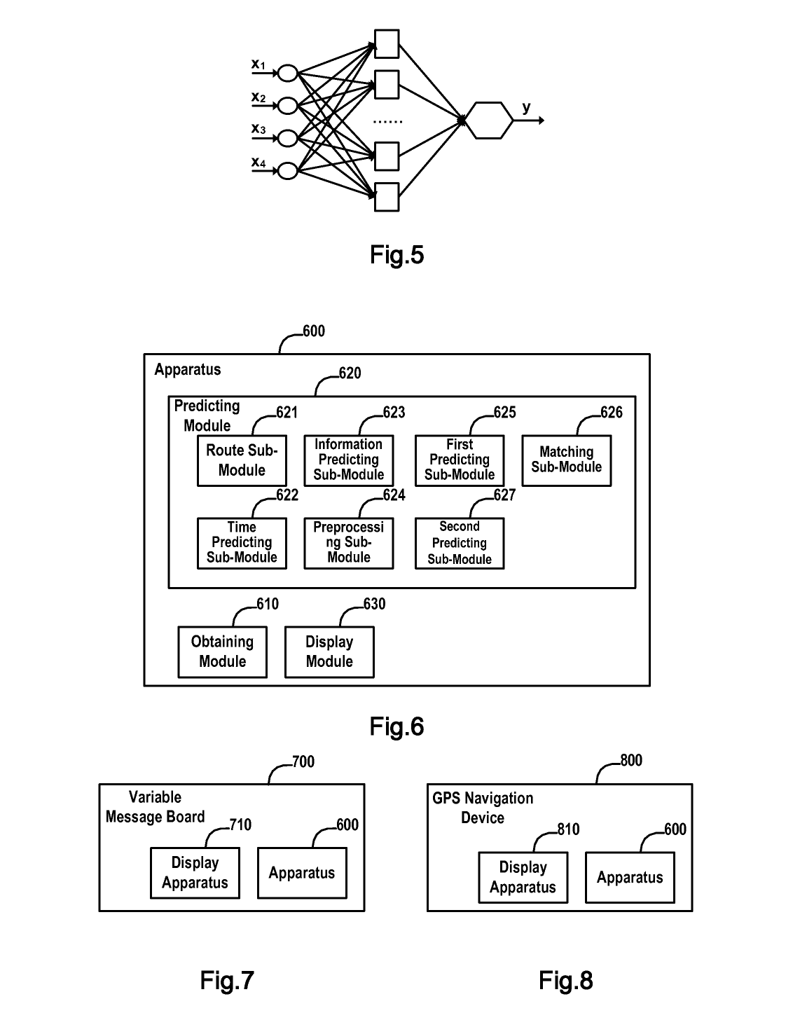

The predicting model can be various mathematical models having a predicting function. For example, the predicting model can be a BP (Back Propagation) neural network model, genetic algorithm model, Bayesian network model, Kalman filter model, etc. FIG. 5 shows an example of employing the BP neural network model as the predicting model, wherein four inputs x₁, x₂, x₃ and x₄ are respectively the real-time traffic flow information of the upstream road sections of the i-th road section, the real-time traffic flow information of the i-th road section, the historical traffic flow information of the i-th road section, and the current traffic guidance information; the output y is the traffic flow information of the i-th road section at time tᵢ. In FIG. 5, circles represent input nodes; blocks represent hidden layer nodes; while hexagons represent output nodes. Alternatively, x4 can be a complete traffic guidance solution constituted with all of the current traffic guidance information so that a more accurate output y can be obtained. In this embodiment, the traffic guidance information is considered into the prediction of the traffic flow information to thereby reflect the influence of the traffic guidance information to drivers and obtain a more accurate predicted result.

In respective embodiments above, the method for obtaining the traffic flow information of the i-th road section at time tᵢ may also be applied to Step 223, that is, Step 223 may employ the same prediction method to predict the traffic flow information of the destination road section at the time of arrival, and tᵢ is taken as the time of arrival. Certainly, Step 223 may also employ other prediction methods to predict the traffic flow information of the destination road section at the time of arrival.

The above method embodiments of the present invention may have reference to and be combined with each other to thereby obtain more embodiments. For example, by the combination of embodiments, Step 220 may include: pre-processing the obtained data; matching the pre-processed data with an electronic map to obtain standby traffic flow information of a plurality of road sections; predicting, based on the standby traffic flow information of a plurality of road sections, traffic flow information of the plurality of road sections at different time.

With the method provided by above embodiments, drivers can be provided with more accurate future traffic flow information, and based on drivers' requirements, the drivers can be provided with the traffic flow information of different road sections at different time, especially the traffic flow information of a certain road section at an expected time when arriving at the certain road section from the current position so as to avoid the drivers' blind selection of roads and effectively play the role of traffic guidance and improve user's experience. Furthermore, by taking into account the behavior predicting model of the drivers and the influence of the traffic guidance information to the drivers in traffic flow prediction, the accuracy of prediction is further improved so that the accuracy of information provided to the drivers is guaranteed.

As shown in FIG. 6, embodiments of the present invention provide a traffic information processing apparatus 600. The apparatus 600 comprises: an obtaining module 610 configured to obtain road traffic data of a plurality of road sections; a predicting module 620 configured to predict for at least two road sections of the plurality of road sections, based on the obtained data, traffic flow information at an expected time when arriving at the road section from a current position, wherein the traffic flow information is used for describing a traffic state of a road; a display module 630 configured to display via a display apparatus the predicted traffic flow information of at least two road sections in the at least two road sections. The apparatus provided in this embodiment can display the traffic flow information of different road sections in different time periods to a user so that the user can select a route based on the traffic flow information of different road sections in different time periods, especially based on the traffic flow information in the time period that the user may arrive at the road section. It provides more convenient, accurate traffic guidance information, greatly improves the user's faith in the displayed information, and thus can play a better role as a traffic guider and meanwhile improve the user's experience. It can be seen that since what provided to the user is the traffic flow information at the expected time for the user's arrival at the road section, the user can master the entire traffic flow conditions in his/her own travel route, thereby improving the user's experience and performing a better role as a traffic guider.

In one embodiment of the present invention, the predicting module 620 is configured to take the traffic guidance information as one of influencing factors for prediction, and predict for at least two road sections of the plurality of road sections, based on the obtained data, traffic flow information at an expected time when arriving at the road section from a current position, wherein the traffic guidance information comprises at least part of the information displayed by the display apparatus. In the predicting, taking into account the influence of the traffic guidance information on the driver may make the predicted results more accurate and thereby further improve user's experience and the traffic guiding function.

In one embodiment of the present invention, the predicting module 620 comprises: a pre-processing sub-module 624 configured to pre-process the obtained data; and a first predicting sub-module 625 configured to predict, based on the pre-processed data, traffic flow information of a plurality of road sections at different time.

In one embodiment of the present invention, the predicting module 620 comprises: a matching sub-module 626 configured to match the obtained data with an electronic map to obtain standby traffic flow information of a plurality of road sections, the standby traffic flow information including at least one of historical traffic flow information and real-time traffic flow information; a second predicting sub-module 627 configured to predict, based on the standby traffic flow information of the plurality of road sections, traffic flow information of the plurality of road sections at different time.

In one embodiment of the present invention, the predicting module 620 comprises: a route sub-module 621 configured to determine a route from a current position to a destination road section, wherein each of the at least two road sections of the plurality of road sections is respectively taken as the destination road section; a time predicting sub-module 622 configured to predict time of arrival when arriving at the destination road section via the determined route; an information predicting sub-module 623 configured to predict traffic flow information of the destination road section at the time of arrival.

In one embodiment of the present invention, the route sub-module 621 is configured to judge, based on a behavior predicting model, a most probably selected route from the current position of the display apparatus to the destination road section and take the most probably selected route as the finally determined route. Specifically, how to make the judgment based on the behavior predicting model may refer to the method embodiments and thus is not detailed here.

In one embodiment of the present invention, the time predicting sub-module 622 is configured to: respectively obtain a time length Tᵢ required for passing through each road section of the determined route, wherein Tᵢ is obtained based on the traffic flow information of a corresponding road section at time t_{i,} 1≦i≦k, t₁ is the current time, tᵢ=tᵢ₋₁+Tᵢ₋₁, k is the number of the road sections contained in the determined route; obtain the time of arrival based on the obtained time lengths required for passing through respective road sections, wherein reference can be made to the method embodiments for the specific embodiments of the time predicting sub-module 622, and thus it is not detailed here.

In one embodiment of the present invention, at least one of the historical traffic flow information of the i-th road section, the real-time traffic flow information of the i-th road section and the real-time traffic flow information of the upstream road section of the i-th road section, and the traffic guidance information at current time are taken as an input to obtain, based on a predicting model, traffic flow information of the i-th road section at time wherein 1<i≦k, the traffic guidance information comprises at least part of the information displayed by the display apparatus. The embodiments of the specific prediction may be applied to the time predicting sub-module 622 and may also be applied to the information predicting sub-module 623.

The above embodiments of respective apparatuses can be combined with each other to obtain more embodiments, and thus it is not detailed here. Reference can be made to the method embodiments for details.

As shown in FIG. 7, embodiments of the present invention further provide a variable message board 700. The variable message board 700 comprises a display apparatus 710 and the apparatus 600 as shown in FIG. 6, wherein the apparatus 600 can display traffic flow information via the display apparatus 710.

As shown in FIG. 8, embodiments of the present invention further provide a GPS navigation device 800. The GPS navigation device 800 comprises a display apparatus 810 and the apparatus 600 as shown in FIG. 6, wherein the apparatus 600 can display traffic flow information via the display apparatus 810.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A traffic information processing method, comprising:
obtaining road traffic data of a plurality of road sections;
predicting traffic flow information, based on the obtained data, for at least two road sections of the plurality of road sections at an expected time when arriving at a road section from a current position, the traffic flow information being used for describing a traffic state of a road; and
displaying the predicted traffic flow information of at least two road sections in the at least two road sections via a display apparatus.

2. The method according to claim 1, wherein predicting the traffic flow information comprises:
matching the obtained data with an electronic map to obtain standby traffic flow information of the at least two road sections, the standby traffic flow information comprising at least one of historical traffic flow information and real-time traffic flow information; and
predicting the traffic flow information for the at least two road sections, based on the standby traffic flow information of the at least two road sections, at the expected time when arriving at the road section from the current position.

3. The method according to claim 1, wherein predicting the traffic flow information comprises:
taking traffic guidance information as influencing factor for predicting the traffic flow information, and predicting for at least two road sections of the plurality of road sections, based on the obtained data, at the expected time when arriving at the road section from the current position, wherein the traffic guidance information comprises at least part of the information displayed by the display apparatus.

4. The method according to claim 1, wherein predicting the traffic flow information comprises:
determining a route from the current position to a destination road section, wherein each of the at least two road sections of the plurality of road sections is respectively taken as the destination road section;
predicting time of arrival at the destination road section via the determined route; and
predicting the traffic flow information of the destination road section at the time of arrival.

5. The method according to claim 4, wherein determining a route from the current position to a destination road section comprises:
judging, based on a behavior predicting model, a selected route from the current position to the destination road section and taking the most probably selected route as the finally determined route.

6. The method according to claim 4, wherein predicting the time of arrival at the destination road section via the determined route comprises:
respectively obtaining a time length Tᵢ required for passing through each road section of the determined route, wherein Tᵢ is obtained based on the traffic flow information of a corresponding road section at time tᵢ, 1≦i≦k, t₁ is the current time, tᵢ=tᵢ₋₁+Tᵢ₋₁, and k is the number of road sections contained in the determined route; and
obtaining the time of arrival based on the obtained time lengths required for passing through respective road sections.

7. The method according to claim 6, wherein the traffic flow information of a corresponding road section at time tᵢ is obtained by the step of:
taking at least one of:
historical traffic flow information of an i-th road section,
real-time traffic flow information of the i-th road section and real-time traffic flow information of an upstream road section of the i-th road section, and
traffic guidance information at the current time as an input to obtain, the traffic flow information of the i-th road section at time tᵢ based on a predicting model,
wherein 1<i≦k, and
wherein the traffic guidance information comprises at least part of the information displayed by the display apparatus.

8. The method according to claim 1, wherein the current position comprises a position where the display apparatus is currently located.

9. The method according to claim 1, wherein the expected time when arriving at the road section comprises one of: an expected time point of arrival at the road section and an expected time period of arrival at the road section.

10. A traffic information processing apparatus, comprising:
an obtaining module configured to obtain road traffic data of a plurality of road sections;
a predicting module configured to predict traffic flow information, based on the obtained data, for at least two road sections of the plurality of road sections at an expected time when arriving at the road section from a current position, wherein the traffic flow information is used to describe a traffic state of a road;
a display module configured to display via a display apparatus the predicted traffic flow information of at least two road sections in the at least two road sections.

11. The apparatus according to claim 10, wherein the predicting module is configured to take traffic guidance information as influencing factor for predicting the traffic flow information, and predict the traffic flow information for at least two road sections of the plurality of road sections, based on the obtained data, at the expected time when arriving at the road section from the current position, wherein the traffic guidance information comprises at least part of the information displayed by the display apparatus.

12. The apparatus according to claim 10, wherein the predicting module comprises:
a route sub-module configured to determine a route from the current position to a destination road section, wherein each of the at least two road sections of the plurality of road sections is respectively taken as the destination road section;
a time predicting sub-module configured to predict time of arrival at the destination road section via the determined route;
an information predicting sub-module configured to predict the traffic flow information of the destination road section at the time of arrival.

13. The apparatus according to claim 12, wherein the route sub-module is configured to judge, based on a behavior predicting model, a most probably selected route from the current position to the destination road section and take the most probably selected route as a finally determined route.

14. The apparatus according to claim 12, wherein the time predicting sub-module is configured to:
respectively obtain a time length Tᵢ required for passing through each road section of the determined route, wherein Tᵢ is obtained based on the traffic flow information of a corresponding road section at time tᵢ, 1≦i≦k, t₁ is the current time, tᵢ=tᵢ₋₁+Tᵢ₋₁, and k is the number of the road sections contained in the determined route; and
obtain the time of arrival based on the obtained time lengths required for passing through respective road sections.

15. The apparatus according to claim 14, wherein at least one of historical traffic flow information of an i-th road section, real-time traffic flow information of the i-th road section and real-time traffic flow information of an upstream road section of the i-th road section, and the traffic guidance information at the current time are taken as an input to obtain the traffic flow information of the i-th road section at time tᵢ based on a predicting model, wherein 1<i≦k, and the traffic guidance information comprises at least part of the information displayed by the display apparatus.

16. A variable message board, comprising a display apparatus and the apparatus according to claim 10.

17. A GPS navigation device, comprising a display apparatus and the apparatus according to claims 10.

18. A non-transitory computer readable article of manufacture tangibly embodying computer readable instructions which, when executed, cause a computer to carry out a method comprising the steps of:
obtaining road traffic data of a plurality of road sections;
predicting traffic flow information, based on the obtained data, for at least two road sections of the plurality of road sections at an expected time when arriving at a road section from a current position, the traffic flow information being used for describing a traffic state of a road; and
displaying the predicted traffic flow information of at least two road sections in the at least two road sections via a display apparatus.
